(19) United States
(12) Patent Application Publication
(10) Pub. No.: US 2006/0165424 A1
(43) Pub. Date: Jul. 27, 2006

(54) Xerographic photoreceptor thickness measuring method and apparatus

(75) Inventors: Charles H. Tabb, Penfield, NY (US); Gerald M. Fletcher, Pittsford, NY (US); Bert Peeters, Venray (NL)

Correspondence Address: Patrick R. Roche;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 11/043,380

(22) Filed: Jan. 26, 2005

(51) Int. Cl. G03G 15/00

(52) U.S. Cl. 399/48

(57) ABSTRACT

In a xerographic machine (10) having, a photoreceptor (110) including a photoconductive layer (112) arranged over an electrically conductive substrate (114), and a charging station (200) for applying a substantially uniform electrostatic charge to a surface (116) of the photoconductive layer (112), a method for detecting a thickness (t) of the photoconductive layer (112) is provided. The method includes: measuring an electrical property of the charging station (200); and, determining the thickness (t) of the photoconductive layer (112) from the measured electrical property.

### BACKGROUND

The present inventive subject matter relates to the art of photoreceptor thickness measurement. It finds particular application in conjunction with xerographic machines, and will be described with particular-reference thereto. However, one of ordinary skill in the art will appreciate that it is also amenable to other like applications.

As is known in xerography, a xerographic machine employs a photoreceptor (PR) to produce or reproduce an image on an output media such as paper. The photoreceptor (PR) is typically constructed of a photoconductive layer (PCL) arranged over an electrically conductive substrate. In response to light exposure, the photoconductive layer acts as an electrical conductor or as an electrical insulator. The photoreceptor commonly takes the form of a cylindrical drum, belt or other suitable form.

The photoreceptor is prepared to receive a latent image thereon by a charging process wherein a substantially uniform electrical charge is induced on the photoreceptor surface by a charging device, e.g., a corotron, scorotron, dicorotron, bias charge roll (BCR), etc. The latent image is formed on the charged photoreceptor by projecting onto it a pattern of light corresponding to the desired image being formed. In accordance with the light pattern to which the photoreceptor was exposed, the charge on the surface of the photoreceptor is selectively discharged or altered such that the latent image is formed and/or represented by the electrostatic difference or variation across the surface of the photoreceptor.

Typically, an electrically charged toner is applied to the photoreceptor containing the latent electrostatic image, thereby developing a visible toner image on the surface of the photoreceptor. The toner image is eventually transferred and fused to the output media. Commonly, after the transferring and fusing processes, any excess toner remaining on the photoreceptor is removed so that the photoreceptor is again ready for charging.

Variations in the thickness of the photoconductive layer can be experienced for a variety of reasons. For example, in a given photoreceptor, the thickness of the photoconductive layer may be reduced over time due to standard wear-and-tear. In another example, the thicknesses of photoconductive layers from photoreceptor to photoreceptor may vary due to inexact manufacturing tolerances.

The charging and/or discharging response of the photoreceptor and/or other photoreceptor characteristics can be affected by the thickness of the photoconductive layer. Therefore, unpredictable changes in the photoconductive layer thickness may ultimately effect the image quality of the xerographic machine absent any corrective measures. However, by knowing the thickness of the photoconductive layer at any given time, some degree of compensation can be achieved.

Accordingly, a new and improved apparatus and/or method for determining the thickness or thickness changes of a xerographic photoreceptor is disclosed that overcomes the above-referenced problems and others.

### BRIEF DESCRIPTION

In accordance with one exemplary embodiment, a method for detecting a thickness of a photoconductive layer is provided in a xerographic machine having, a photoreceptor including the photoconductive layer arranged over an electrically conductive substrate, and a charging station for applying a substantially uniform electrostatic charge to a surface of the photoconductive layer. The method includes: measuring an electrical property of the charging station; and, determining the thickness of the photoconductive layer from the measured electrical property.

In accordance with another exemplary embodiment, a xerographic machine includes: a photoreceptor including a photoconductive layer arranged over an electrically conductive substrate, said photoconductive layer having a thickness; a charging station that applies a substantially uniform electrostatic charge to a surface of the photoconductive layer; and, a detection system that detects the thickness of the photoconductive layer by measuring an electrical property.

Numerous advantages and benefits of the inventive subject matter disclosed herein will become apparent to those of ordinary skill in the art upon reading and understanding the present specification.

### BRIEF DESCRIPTION OF THE DRAWINGS

The present inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration showing a xerographic machine embodying aspects of the present inventive subject matter.

FIG. 2 is a diagrammatic illustration showing a side view of a suitable embodiment of the charging station and thickness detection system shown in FIG. 1.

FIG. 3 is a diagrammatic illustration showing an end view of another suitable embodiment of the charging station and thickness detection system shown in FIG. 1.

FIG. 4 is a graph showing a substantially linear curve representing a plot of V_{G} in relation to I_{C} minus I_{G} for the scorotron shown in FIG. 3.

FIG. 5 is a graph showing a substantially linear curve representing a plot of V_{PR} in relation to I_{PR} for the photoreceptor shown in FIG. 3.

### DETAILED DESCRIPTION

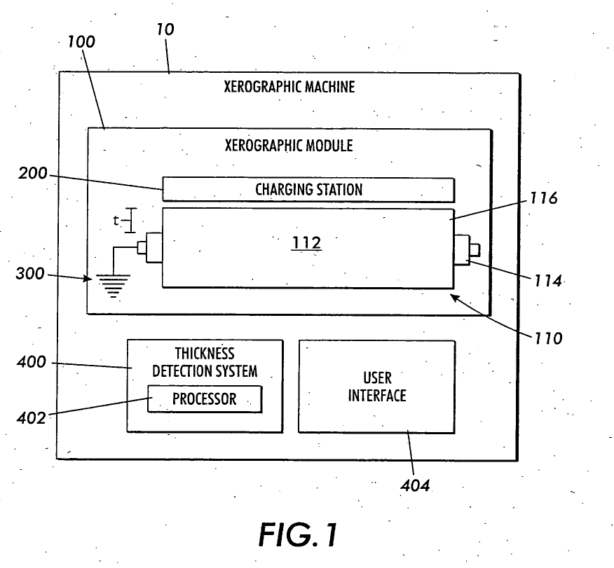

With reference to FIG. 1, there is illustrated a xerographic machine 10 which may be a printer, copier, multifunction device or like electrostatographic apparatus. Housed within the machine 10 is a xerographic module, indicated generally by reference numeral 100, including a photoreceptor 110 and a charging station 200. The photoreceptor 110 includes a photoconductive layer 112, having a thickness t, that is arranged over an electrically conductive substrate 114 which is electrically grounded, e.g., to a ground potential 300. As shown, the photoreceptor 110 takes the shape of a cylindrical drum, but alternately, it may be a belt type photoreceptor or take another suitable form. Suitably, a motor (not shown) engages with the drum for rotating the drum to advance successive portions of the photoconductive surface 116 through various processing stations disposed about the path of movement thereof, as is well known in the art. Initially, a portion of the drum passes through the charging station 200 where a charging device charges the photoconductive surface 116 (in preparation for imaging) to a relatively high, substantially uniform potential.

The xerographic machine 10 is also equipped with a thickness detection system 400. The thickness detection system 400 detects the thickness of the photoconductive layer 112. A processor 402 or other similar controller suitably regulates the operation of the respective components of the xerographic machine 10 to conduct a thickness detection process. Optionally, a user interface 404 including input and/or output devices permits a user to manually initiate the thickness detection process and/or obtain the results. Alternately or in addition to manual operation, the thickness detection process is optionally run automatically on a determined schedule or at specified times. Optionally, in response to the obtained thickness results, imaging, charging and/or other operating parameters of the xerographic machine 10 are automatically adjusted by the processor 402 to compensate for a detected change in the thickness t.

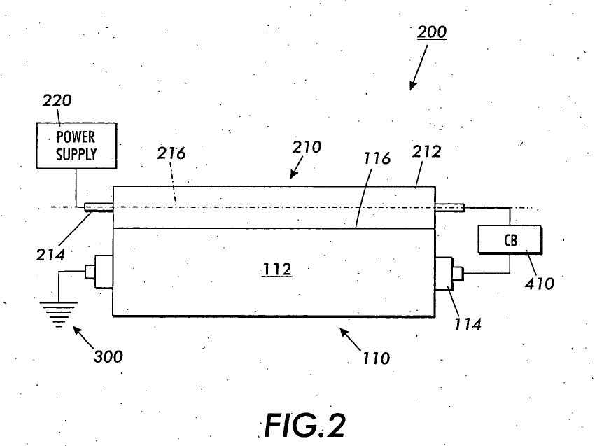

In a suitable embodiment (as shown in FIG. 2), the charging station 200 includes a charging device that takes the form of a bias charge roll (BCR) system 210. The BCR system 210 may be any standard BCR system as is know in the art, for example, as disclosed in U.S. Pat. Nos. 6,807,389 and 5,613,173, incorporated herein by reference in their entirety.

Referring now, more particularly, to the illustrated BCR system,210, an electrically conductive roll member 212 is provided in contacting engagement with the photoconductive surface 116 of the photoreceptor 110. The roll member 212 is axially supported on an electrically conductive core or shaft 214, situated transverse to the direction of relative movement of the photoreceptor 110. Suitably, the roll member 212 is provided in the form of a deformable, elongated roller supported for rotation about an axis 216 and is optionally comprised of a polymer material such as, for example, Neoprene, F.P.D.M. rubber, Hypalon rubber, Nitrile rubber, Polyurethane rubber (polyester type), Polyurethane rubber (polyether type), Silicone rubber, Viton/Fluorel Rubber, Epichlorohydrin rubber, or other similar materials having a D.C. volume resistivity in the range of 10³ to 10⁷ ohm-cm after suitable compounding with carbon particles, graphite or other conductive additives. These materials are chosen for the characteristic of providing a deformable structure while in engagement contact with the photoreceptor 110, as well as wearability; manufacturability and economy. Suitably, the deformability of the roll member 212 provides a nip having a substantially measurable width while being engaged with the photoreceptor 110. It is to be appreciated that alternative BCR arrangements can have the conductive roll member 212 slightly out of contact with the photoconductor surface 116 at a substantially fixed spacing. In such BCR arrangements, deformability properties of the roll member 212 are not as important. For convenience, the following discussions shall refer to contacting BCR arrangements, but it will be apparent to those skilled in the art that discussions can be readily extended to non-contacting BCR arrangements.

As illustrated, a high voltage power supply 220 is connected to the roll member 212 via shaft 214 for supplying a suitable input drive voltage to the roll member 212, e.g., such as an oscillating input drive voltage, a DC voltage, an AC voltage optionally with or with out a DC offset, etc. Suitably, as known in the art, the oscillating input drive voltage is selected to have a peak-to-peak voltage typically chosen to be high enough to cause air breakdown at small air gap regions between the roll member 212 and the photoreceptor surface 116 very near the contact zone therebetween. The DC offset voltage is suitably chosen based on the desired charge potential to be induced on the photoconductive surface 116. At operating AC voltage conditions, the charge potential induced on the photoconductive surface 116 will typically be near or equal to the DC offset voltage. While it is possible to use a standard line voltage, other voltage levels or voltage signal frequencies may be desirable in accordance with other factors dependent on individual machine design, such as the desired charge level to be induced on the photoreceptor 110, or the speed of copying and/or printing operations desired. Accordingly, a charging operation involves the application of a voltage signal from the BCR system 210 to the photoconductive surface 116 of photoreceptor 110 in the usual manner, which creates a voltage potential across the photoreceptor 110 to ground 300.

In the current embodiment, the thickness detection system 400 (FIG. 1) operates by measuring the capacity C between the BCR system 210 and the photoreceptor 110, and therefrom deriving the thickness or changes in the thickness t of the photoconductive layer 112. Alternatively or optionally (as more fully described later herein), electrical signals are sensed that are related to the capacity C and used to derive the thickness or changes in the thickness t of the photoconductive layer 112. Notably, the following equation provides a relevant relationship:
C=e₀[Aₙᵢₚ/(tK+dₐᵢᵣ₀)]+CS (1);
where C is the measured capacity. In equation (1), it should be noted that the capacity of the roll member (i.e., the layer between the shaft 214 and the outer photoconductor contacting surface of the roll member 212) has been neglected, and this is generally a good approximation for practical arrangements. The right hand side of equation (1) includes: a first term for the capacity related to the contacting nip area between the roll member 212 and the photoconductor surface 116; and, a second term CS representing the capacity between the roll member 212 and the photoconductor substrate 114 in the air gap regions between the roll member 212 and photoconductor 110 that are beyond the contacting nip. In equation (1), Aₙᵢₚ is the contact area between the roll member 212 and the surface 116 of the photoreceptor 110, dₐᵢᵣ₀ represents a very small air gap that can be present between the contacting roll member 212 and the photoconductive layer 112 in the nip, e₀ is the permittivity of free space, and K is the dielectric constant of the photoconductive layer 112, such that e₀×K=ε, where ε is the permittivity of the photoconductive layer 112. While not explicitly identified herein, it suffices to note that specific expressions for the CS term, while potentially complex, are derivable by those skilled in the art. For a typical BCR system, the CS term is generally significantly smaller than the first term of equation (1), and it is weakly dependant on the photoconductive layer thickness, if at all. For a contacting BCR system (such as the exemplary illustrated BCR system 210), the dₐᵢᵣ₀ term is often small compared to the t/K term. Notably, for most BCR systems, dₐᵢᵣ₀ is relatively constant.

For simple-cases where CS is suitably small compared to the first term in equation (1), solving equation (1) for t gives:
t=ε(AₙᵢₚC)−Kdₐᵢᵣ₀ (2).
In this simple case, there is a linear dependence of t on the measured capacity C. In more general cases where the CS term is not sufficiently negligible, the dependence of the thickness t on the measured capacity C may more complex than equation (2) suggests. Also, in some very general cases, the photoconductor 110 may have some level of conductivity or can have somewhat complex dielectric properties, and this may further affect the relationship between the thickness t and the measured capacity C. Also, while equation (1) would suitably maintain a similar form, it is modified somewhat for a BCR arrangement having a roll member that is spaced from the photoconductor. In any event, there remains a defined relationship between the measured capacity C and the thickness of the photoconductive layer, that is suitably derivable.

As an alternative to analytical determination, the relationship between C and t is determined experimentally for the actual BCR configuration and photoconductor employed in a particular application. This is done, for example, by purposely varying the thickness t (e.g., via deliberate wearing or another representative means) in one or more models or test machines, and measuring the resultant capacity C at a plurality of different thicknesses (e.g., which are known or otherwise accurately determined or measured using standard techniques). Accordingly, a look-up table or the like is generated relating capacity to thickness. Advantageously, the experimental approach readily accounts for possible sources of complexity that might affect the relationship between t and C. Once the specific relationship between t and C is established and available, e.g., in a look-up table, subsequent measurements of C, in a machine having the same or similar configuration as the models or test machines, can be used to readily determine t or changes thereto.

Suitably, a capacitance-bridge (CB) 410 (optionally part of the detection system 400) is employed to measure the capacity C between the BCR system 210 and the photoreceptor 110. Alternately, another capacity measuring device is employed. In the illustrated embodiment, the CB 410 is operatively connected between the shaft 214 of the roll member 212 and the conductive substrate 114 of the photoreceptor 110. Optionally, the processor 402 (FIG. 1): (i) obtains the capacity measurement C from the CB 410 or another measuring device; (ii) utilizes the look up table described above (e.g., stored in a memory or other storage device) to determine the thickness t that corresponds to the measured capacity C; and, outputs the result. Alternately, the processor 402 utilizes the capacity measurement C to determine the thickness t by calculating or executing an appropriate analytical expression, such as equation (2) or the like, which reflects or approximates the relationship between C and t. Suitably, known terms (e.g., Aₙᵢₚ, e₀, K, etc.) in the analytical expression are provided or otherwise provisioned in the processor 402 or stored in a memory or other storage device.

As described above, measurements of capacitance in the BCR system 210 are used to determine the thickness t or changes in the thickness t. Another suitable embodiment uses measurement of the AC current flow between the BCR system 210 and the photoconductor substrate 114 instead of measured capacitance. Notably, this AC current is related to the capacitance. Actually, the AC current flow between the roll member 212 and the photoconductor 110 has a “corona current” component in addition to the capacitive component, but this does not create any issues related to using AC current as a surrogate, instead of a capacitance measurement, to determine photoconductor thickness. As is known in the art, a controlled air breakdown or ionization generally referred to as “corona” occurs in small air gap regions between the roll member 212 and the photoconductor 110 due to the application of suitably high AC potentials. The corona current component of the AC current flow between the roll member 212 and the photoconductor 110 is out of phase with the capacitive current flow component therebetween, but it still adds to the total current. Also, the corona current component of the total current increases or decreases as the photoconductive layer 112 increases or decreases in thickness. Therefore, an increase in total current corresponds to a decrease in t, and thus a relationship between the AC current and t can be established. Suitably, the specific relationship is established by using similar analytical and/or experimental techniques such as those previously described. As in the capacitance case, experimental determination has similar advantageous. Suitably, the experimentally determined correspondence between measured AC current and t is supplied to a look up table. Later measurements of the AC current between the BCR system 210 and the photoconductor 110 are then used to readily determine the thickness t and/or changes therein.

Optionally, the AC current between the BCR system 210 and the photoconductor 110 is measured directly with a current meter 412 (or other AC current detector, sensor or monitor system) placed between the photoconductor 110 and ground connection 300. This arrangement is particularly suitable, e.g., if the AC current flow to the photoconductor substrate 114 from the BCR system 210 is sufficiently higher than the AC current flow to the substrate 114 from other charging sources delivering current to the photoconductor 110 in the xerographic module 100, such as the development system, etc. If other AC current sources to the photoconductor 110 are relatively high in magnitude (i.e., sufficiently close to that of the BCR system 210), but are of a sufficiently different operating frequency than the BCR system 210, a phase detection sensor or circuitry is optionally employed to separate the AC BCR current from these other sources. Alternatively, the AC BCR current is monitored at the power supply 220. Measurement of the current at the supply is, however, potentially disadvantageous to the extent that it may include a high level of AC leakage current, e.g., due to stray capacitance to ground between the high voltage power supply output lead and the roll member connection contact, which effect is depicted generally in FIG. 2 by the phantom (i.e., dashed line) circuit indicated generally as reference numeral 500. Optionally, this stray capacitive current flow is maintained relatively low by creating low capacitance between the high voltage power supply leads and nearby grounds. Alternatively, it is made to be relatively constant and subtracted from the total power supply current to thereby derive a signal that is substantially mainly the AC current delivered between the BCR system 210 and photoconductor 110.

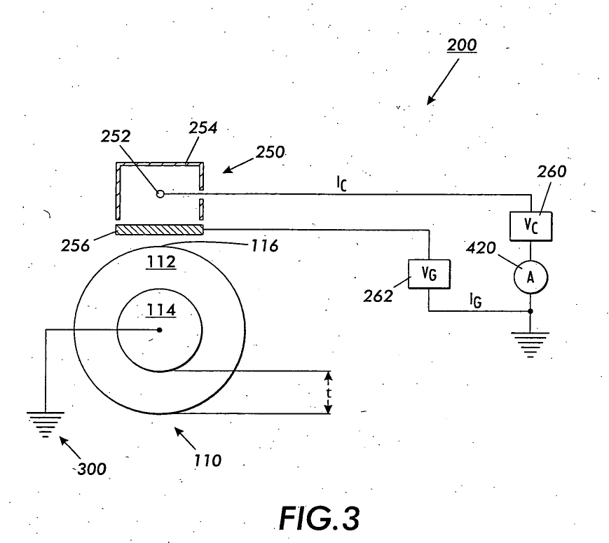

In another suitable embodiment (as shown in FIG. 3), the charging station 200 includes a corona generating device positioned near the photoreceptor 110. While described with reference to the illustrated scorotron 250, the principles described apply to a variety of charging devices, including: other corona generating devices (e.g., a dicorotron or corotron); or, BCR systems such as those previously discussed.

The scorotron 250 is suitably configured and/or arranged as any conventional scorotron. The exemplary scorotron illustrated includes a coronode 252, a shield 254, and a grid 256. Suitably, the coronode 252 is a fine electrically conductive wire or thin rod elongated substantially parallel with the photoreceptor 110. Alternately, the coronode 252 is formed from an electrically conductive sheet of material with a sawtooth cut edge or comb-shaped pin arrangement facing the photoreceptor 110, the sawtooth points or comb-shaped pins forming what is known as scorotron pins. Suitably, the shield 254 is a typically a u-shaped or other suitably shaped electrically conductive member extending the length of and surrounding the coronode 252 with its open side facing the photoreceptor 110. The grid 256 is suitably positioned across the open side of the shield 254 between the coronode 252 and the photoreceptor 110. During charging of the photoconductor 110, the grid 256 helps control the strength and uniformity of the charge placed on the photoreceptor 110. Suitably, the grid 256 is formed from an electrically conductive, perforated material, e.g., from a thin metal film having a pattern of spaced perforations opened therein. Alternately, the grid 256 is formed from a weave or lattice of electrically conductive wires with openings therebetween.

While not shown, in yet another suitable embodiment, the grid and shield may be optionally combined with the grid forming a u-shape or other suitable shape. This alternate embodiment is particularly applicable to a scoroton employing a pin style coronode.

Returning attention now to FIG. 3, as indicated by the simplified electrical schematic depicted therein, a first power supply or high voltage source 260 is connected to the coronode 252 for providing a suitable input drive voltage to the same. Similarly, a second power supply or high voltage source 262 is connected to the grid 256 for providing a suitable input drive voltage thereto and to the shield 254. While not shown, optionally the shield 254 is also provided a suitable input drive voltage in certain circumstances. The low voltage side of the power supplies are connected together and then connected to ground through a current meter or sensor or other current monitor system 420. As can be seen from FIG. 3, the current measured by the monitor 420 is the quantity A_{M}=I_{C}−I_{G}, which in turn is the current flow delivered between the device 250 and the photoconductor 110. When the current A_{M} is DC and is measured during rotation of the photoconductor in a xerographic machine, it is typically referred to as the “dynamic” DC current.

Suitably, for the charging process, the grid 256 is maintained at a high D.C. voltage potential V_{G} and the coronode 252 is supplied a high D.C. voltage potential V_{C} that is optionally varied to maintain a substantially constant current flow I_{C} to the coronode 252. Typically, the potential of the first high voltage source 260 is in the range of approximately 1 to 10 kilovolts (kV), often about 6 kV. Typically, with a well designed scorotron, the resulting photoconductor potential after passage through the device is near the value of the potential supplied to the grid V_{G}. For example, during the charging process, the coronode is supplied a potential V_{C} of around 6 kV and the grid 254 is maintained at a potential V_{G} in the range of approximately 0.3 kV to 1.5 kV, suitably at about 0.6 kV. In certain cases, optionally, the shield 254 may also be biased, e.g., to the same potential as the grid 256 or to some other potential depending on the type of corona device being used. Accordingly, in the usual manner, the charging process involves ionization of the surrounding air or generation of a corona by appropriately energizing the various components of the scorotron 250, thereby a charge is transferred and/or applied to the photoconductive surface 116 which creates a voltage potential V_{PR} across the photoreceptor 110 to ground 300.

In the current embodiment, the thickness detection system 400 (FIG. 1) operates by monitoring the total dynamic DC current delivered to the photoreceptor 110 as the charging voltages or currents are varied.

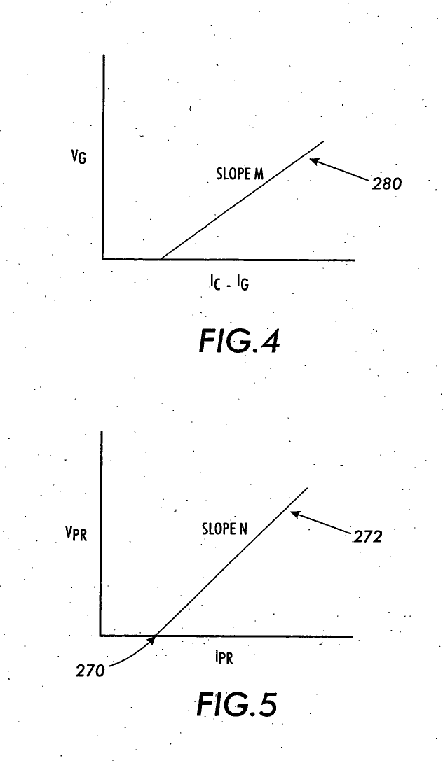

With added reference to FIGS. 4 and 5, with many photoconductor and charging system arrangements the curves shown are typically linear, but this is not strictly the case nor is it demanded herein. Suitably, the slope m of the photoreceptor current I_{PR} to grid potential V_{G} is generally substantially equal to or proportional to the slope n of the photoreceptor current I_{PR} to photoreceptor potential V_{PR}. More importantly, the slope n is related to the thickness t of the photoconductive layer 112 by the photoreceptor velocity (i.e., the linear velocity of the surface 116 as the photoreceptor 110 is being rotated) and the charging process length (i.e., the length of the coronode 252). Suitably, the current delivered to the photoreceptor 110 is monitored by sensing the current A_{M} in FIG. 3, which is the current I_{c} delivered to the coronode 252 by the first power supply 260 minus the current I_{G} delivered to the grid's power supply, i.e., the second power supply 262.

Notably, the thickness t of the photoconductive layer 112 is related to the photoreceptor's surface charge density and voltage in accordance with the following equation:
t/K=e₀(V_{PR}/CD) (3);
where CD is the charge density or charge per area on the surface 116 of the photoconductor 110. Note the term t/K represents the so called dielectric thickness.

With particular reference to FIG. 5, in photoreceptor manufacturing, the dielectric thickness t/K of the photoconductive layer 112 is characterized by measuring the dynamic charging current as the charging voltage is varied. The plot of charge voltage to current is typically substantially linear. The intercept 270 of this curve 272 is taken as a measurement of non-capacitive charging or depletion. Due to depletion, some of the initial charge density provided by the dynamic DC current from the charging device does not remain on the surface of the photoconductor and hence does not contribute to a change in the photoconductor voltage V_{PR}. At dynamic currents above the depletion threshold, the photoconductor typically behaves more like a simple dielectric and hence the curve beyond the depletion current condition is generally of most interest relative to thickness changes. The slope n of this curve 272 is used to characterize the photoreceptor's capacitance and/or the dielectric thickness t/K. Accordingly, given a slope n that provides substantially equal changes in voltage due to like changes in capacitive current, then equation (3) can be rewritten as:
t/K=e₀×n×VEL_{PR}×L (4);
where VEL_{PR} is the photoreceptor velocity, and L is the charging process length. Note that the length term converts from current to current per length, and the velocity term converts from current per length to charge per area, i.e., CD. Note also that any constant non-surface charge residual voltage will only contribute to the intercept 270 and not the slope n.

Turning attention now to FIG. 4, the photoreceptor voltage V_{PR} is substantially proportional to the grid potential V_{G} provided the scorotron 250 is suitably optimized or otherwise appropriately provisioned and/or functioning. Accordingly, the slope m is also substantially proportional (or equal) to the slope n. Therefore, equation (4) can be rewritten as:
t=e₀×K×G×m×VEL_{PR}×L (5);
where G is a factor of proportionality such that:
V_{PR=G×V}_{G}+C (6);
where C is a constant. Suitably, G is constant or varies in a well defined way with changes in I_{C}.

Suitably, a current meter 420 or other current sensing device (optionally part of the detection system 400) is operatively connected to the circuit depicted in FIG. 3 to measure or otherwise sense the current at its indicated location. In this manner, the meter 420 effectively measures the term (I_{C}-I_{G}). It is to be noted that I_{PR} is substantially equivalent to I_{C} minus I_{G}. Optionally, at a plurality of different charging voltages, the processor 402 (FIG. 1) obtains the measurement from the meter 420 and the grid potential V_{G} and therefrom calculates or otherwise determines the slope m of the curve 280, performs the above calculation from equation (5), and outputs the result. Suitably, the parameters e₀, K, G, VEL_{PR}, and L are programmed or otherwise provisioned in the processor 402.

The discussions thus far have utilized simple relationships between the thickness t and the dynamic currents and grid voltages that suitably apply for most photoconductor systems. However, these relationships potentially become somewhat more complex in other more complex systems having photoconductors where the charging characteristics are more complex than that described. Nevertheless, for both simple and more complex systems, there is a relationship between changes in the dynamic current vs. grid voltage curve and changes in the thickness t. Suitably, this relationship is established experimentally (e.g., during development of the particular system) and a look up table is created that may, for example, not depend on linearity of the curves to determine the corresponding thickness t or changes therein associated with a particular measured change, e.g., in the shape of the dynamic current vs. grid potential curve.

In connection with the particular exemplary embodiments presented herein, certain structural and/or function features are described as being incorporated in particular embodiments. It is to be appreciated that different aspects of the exemplary embodiments may be selectively employed as appropriate to achieve other alternate embodiments suited for desired applications, the other alternate embodiments thereby realizing the respective advantages of the aspects incorporated therein.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to exemplary embodiments. Obviously, modifications and alterations will occur to others upon reading and understanding the present specification. It is intended that the inventive subject matter be construed as including all such modifications and alterations insofar as they come within the scope of the appended claims or the equivalents thereof.

1. In a xerographic machine having, a photoreceptor including a: photoconductive layer arranged over an electrically conductive substrate, and a charging station for applying a substantially uniform electrostatic charge to a surface of the photoconductive layer, a method for detecting a thickness of the photoconductive layer comprising:
(a) measuring an electrical property of the charging station; and,
(b) determining the thickness of the photoconductive layer from the measured electrical property.

2. The method of claim 1, further comprising:
adjusting an operating parameter of the xerographic machine in response to the determined thickness.

3. The method of claim 1, wherein the charging station includes a bias charge roll system having a conductive roll member in contacting engagement with the surface of the photoconductive layer, and step (a) comprises:
taking a capacity measurement between the roll member and the substrate.

4. The method of claim 3, wherein step (b) comprises:
carrying out the following equation:
t=ε(A/C)
where t represents the thickness of the photoconductive layer, C is the measured capacity, A is a contact area between the roll member and the surface of the photoconductive layer, and E is a permittivity of the photoconductive layer.

5. The method of claim 1, wherein the charging station includes a corona generating device powered by an electric circuit to charge the photoreceptor at a charging voltage, and step (a) comprises:
taking a current measurement at a point within the electric circuit.

6. The method of claim 5, wherein the point where the current measurement is taken is selected so as to be substantially equivalent to a current delivered to the photoreceptor during charging.

7. The method of claim 6, wherein the corona generating device is a scorotron including a grid that has a grid voltage potential applied thereto by the electric circuit, and step (a) further comprises:
obtaining the grid voltage potential.

8. The method of claim 7, wherein the corona generating device charges the photoreceptor selectively at a plurality of charging voltages, the method further comprising:
repeating step (a) a plurality of times at different charging voltages such that a grid voltage potential is obtained and a current measurement is taken at each of the different charging voltages.

9. The method of claim 8, further comprising:
determining a slope of a curve defined by a comparison of the obtained grid voltage potentials relative to the corresponding current measurements taken at the different charging voltages.

10. The method of claim 9, wherein step (b) comprises:
carrying out the following equation:
t=e₀×K×G×m×VEL_{PR}×L
where t represents the thickness of the photoconductive layer, e₀ is the permittivity of free space, K is a dielectric constant of the photoconductive layer, G is a factor of proportionality, m is the determined slope, VEL_{PR} is a velocity at which the photoreceptor advances past the charging station, and L is an effective length of the charging station.

11. A xerographic machine comprising:
a photoreceptor including a photoconductive layer arranged over an electrically conductive substrate, said photoconductive layer having a thickness;
a charging station that applies a substantially uniform electrostatic charge to a surface of the photoconductive layer; and,
a detection system that detects the thickness of the photoconductive layer by measuring an electrical property.

12. The xerographic machine of claim 11, wherein an operating parameter of the xerographic machine is adjusted in response to the thickness detected by the detection system.

13. The xerographic machine of claim 11, wherein the charging station comprises:
a bias charge roll system having a conductive roll member in contacting engagement with the surface of the photoconductive layer; and,
said electrical property measured by the detection system includes a capacity between the roll member and the substrate of the photoconductor.

14. The xerographic machine of claim 13, wherein the detection system comprises:
a capacitance bridge operative connected between the roll member and the substrate of the photoconductor to measure the capacity therebetween.

15. The xerographic machine of claim 13, wherein the detection system comprises:
a processor that carries out the following equation:
t=ε(A/C)
where t represents the thickness of the photoconductive layer, C is the measured capacity, ε is a permittivity of the photoconductive layer, and A is a contact area between the roll member and the surface of the photoconductive layer.

16. The xerographic machine of claim 11, wherein the charging station comprises:
a corona generating device powered by an electric circuit to charge the photoreceptor at a charging voltage, said charging voltage being selectively variable between a plurality of different charging voltages.

17. The xerographic machine of claim 16, wherein the corona generating device is a scorotron including a coronode having a first voltage potential applied thereto by a first voltage source, and a grid having a second voltage potential applied thereto by a second voltage source.

18. The xerographic machine of claim 17, wherein the detection system comprises:
a current sensor operatively connected in series between the first and second voltage sources, said current sensor measuring an electrical current passing therethrough at a plurality of different charging voltages.

19. The xerographic machine of claim 18, wherein the detection system further comprises:
a processor that receives the current sensor measurements and obtains the second voltage potentials corresponding thereto, said processor determining a slope of a curve defined by a comparison of the obtained voltage potentials relative to the corresponding current measurements taken at the different charging voltages.

20. The xerographic machine of claim 19, wherein the processor carries out the following equation:
t=e₀×K×G×m×VEL_{PR}×L
where t represents the thickness of the photoconductive layer, e₀ is the permittivity of free space, K is a dielectric constant of the photoconductive layer, G is a factor of proportionality, m is the determined slope, VEL_{PR} is a velocity at which the photoreceptor advances past the charging station, and L is an effective length of the charging station.
